(19) United States
(12) Patent Application Publication
(10) Pub. No.: US 2026/0318431 A1
(43) Pub. Date: Oct. 15, 2026

(54) Y-Pattern Valve Assembly and Method

(71) Applicant: Mogas Industries, Inc., Houston, TX (US)

(72) Inventors: Jose Osuna, Houston, TX (US); Shane Oliver, Spring, TX (US); Paola Martinez, Katy, TX (US); Samir Lakhani, Spring, TX (US); Anton David, Richmond, TX (US)

(21) Appl. No.: 19/101,354

(22) PCT Filed: Sep. 19, 2023
(86) PCT No.: PCT/US23/33140

§ 371 Date: Feb. 5, 2025

Related U.S. Application Data
(60) Provisional application No. 63/407,830, filed on Sep. 19, 2022.

(51) Int. Cl. F16K 11/20; B08B 9/032; F16K 5/06; F16K 5/08; F16L 41/02

(52) U.S. Cl. CPC F16K 11/20; B08B 9/0323; F16K 5/0663; F16K 5/08; F16L 41/023; B08B 2209/032

(57) ABSTRACT

Y-pattern valve assembly and method. Y-block has a relatively enlarged main body, a main leg and Y legs with Y-end flanges removably mated directly to bodies of ball valves having flow control elements, a fixed seat, a spring-driven seat, and a first end closure-connect with a seat recess receiving one of the seats. The other seat is received in a seat recess in the valve body, or a second end closure-connect. The Y legs have central portions between the Y-end flanges and the main body having a smaller outside diameter relative to lateral dimension of the main body.

### CROSS REFERENCE TO RELATED APPLICATIONS

This application claims the benefit of priority to U.S. Ser. No. 63/407,830 filed Sep. 19, 2022.

### BACKGROUND

Severe service ball valves are utilized in several processes and under a variety of conditions, including extreme temperatures, high pressures, abrasive particles, acidic fluids, heavy solids buildup, critical safety applications, large pressure differentials, velocity control, noise control, etc. Severe service ball valves may be characterized as valves suitable for use under relatively high pressures, pressure drops and/or temperatures. Pressure and/or pressure differentials may exceed 0.7 MPa (100 psi), 7 MPa (1000 psi) or even 70 MPa (10,000 psi), and temperatures may exceed 100 °C, 200 °C or even 500 °C. Difficult process streams may be corrosive, may include abrasive particulates, may be prone to solidification unless maintained above a particular temperature, may be prone to solids buildup, and the like. Severe service ball valves are characterized by metal-to-metal sealing contact between the ball and the seats of the valve, which generally include a fixed seat and a spring-driven seat on either side of the flow control element, where best performance is obtained by positioning the fixed seat on the normally low pressure, downstream side of the valve. Because the fixed seat is more critical to proper valve function, serviceability generally demands accessibility of the fixed seat.

In various processes, severe service ball valves may be employed in redundant legs or pathways of a process for a configuration which allows for selectively isolating the two pathways to maintain a process flow (or isolation) via one pathway, while providing service or maintenance on the unused, isolated leg. Likewise, various pathways may be employed in a severe service process in which different process steps may be required depending on the characteristics of a particular stream. In an arrangement that has been used to provide for multiple paths within a system, a multiport manifold was attached to two or more severe service ball valves via an intermediate flanged and bolted connection. However, dead volume in flow paths leading up to and within such alternate legs may be problematic in severe service applications, e.g., solids may accumulate in non-flow areas and/or stresses due to thermal cycling may become extreme. Additionally, flexibility in design to locate the more critical fixed seat.

U.S. Pat. No. 9,366,347 B2 discloses a Y-connector in which the severe service ball valves are formed integrally in the Y-connector to form a multiport valve assembly. However, the resulting assembly is excessively large, very heavy, and difficult to machine, transport and install due to excessive size and weight, and to service owing to machine shop limitations, which are increasingly important as valve size and pressure class increase. For example, a 1500# class 14-in. valve assembly can weigh more than 14,000 kg (31,000 lbs). Moreover, serviceability considerations may dictate the location of the fixed seat on a particular side of the valve which may not align with the process considerations.

### SUMMARY

The present disclosure addresses the valve assembly deadleg, size, weight, and other issues by providing two preferably severe service ball valves that are only partially integrated with the Y-pattern valve assembly at the outlet terminations thereof. The Y-pattern connector is formed from an independent Y-block having flanges on the ends that mate directly with respective valve bodies of the ball valves using cooperating holes and studs. This creates an assembly that comprises at least three main pieces (Y-block and two valve bodies) and is smaller, lighter, cheaper to produce, easier to machine, easier to transport, and easier to service in the field than the '347 patent where valve bodies are machined into the Y-block. For example, in addition to separating portions of the ball valves from the Y-block, in certain embodiments the central portions between the Y-end flanges and a main body of the Y-block may have a smaller outside diameter relative to a lateral dimension of the main body. The deadleg distance is limited to the space needed to accommodate a wrench on the bolts on the studs attaching the Y-end flanges to the valve bodies and is comparable to that of the '347 patent or only slightly longer. Additionally, the design allows flexibility to serviceably position the fixed seat on either side of the ball valve adjacent to or away from the Y-block. Moreover, in certain embodiments disclosed herein, the deadleg space can be conveniently purged, which may further inhibit solids formation while the adjacent ball valve is closed.

Broadly, in one aspect, the invention provides a Y-pattern valve assembly comprising: a Y-block comprising a relatively enlarged main body, a main leg and two Y legs connected to the main body, wherein the Y legs have respective Y-end flanges removably mated directly with valve bodies of respective ball valves, wherein the Y legs comprise central portions between the Y-end flanges and a main body of the Y-block having a smaller outside diameter relative to lateral dimension of the main body. There are process fluid flow passages through the main leg, Y legs, and ball valves. One or preferably both ball valves comprise a flow control element rotatably received in a valve cavity bore formed in the valve body to selectively allow or block the process fluid flow through the valve cavity bore. First and second annular seat recesses separately receive fixed and spring-driven seats having spherical surfaces engaging respective spherical surfaces on opposite sides of the flow control element. A first end closure-connect comprises a first valve attachment flange (which may be the same flange as the Y-end flange) and a first annular axial extension from the first attachment flange received in the valve cavity bore wherein the first annular seat recess is formed in an inner end of the first annular axial extension. The second annular seat recess is formed either in an inner end of a second annular axial extension from a second attachment flange of a second end closure connect, or (where the second end closure-connect is not present) in the valve body.

In a first embodiment, a Y-pattern valve assembly comprises: a Y-block having a main body, a main leg and two Y legs connected to the main body, wherein the Y legs have respective Y-end flanges removably mated directly with valve bodies of respective ball valves. The Y legs comprise central portions between the Y-end flanges and the main body having a smaller outside diameter relative to lateral dimensions of the relatively enlarged main body. There are process fluid flow passages through the main leg, Y legs, and ball valves. One or preferably both ball valves comprise a flow control element received in a valve cavity bore formed in the valve body to selectively allow or block the process fluid flow through the valve cavity bore, first and second annular seat recesses separately receiving fixed and spring-driven seats having spherical surfaces engaging respective spherical surfaces on opposite sides of the flow control element, and an end closure-connect comprising an attachment flange and an annular axial extension from the attachment flange received in the valve cavity bore opposite the Y-block. The first annular seat recess is formed in an inner end of the annular axial extension.

First and second sets of cooperating valve holes and studs removably secure the Y-end flanges and the attachment flange to the valve body, respectively. The second annular seat recess is formed in a coaxial annular shoulder formed around the valve cavity bore in the valve body between the flow control element and the Y-end flange, wherein the second annular seat recess is spaced from and independent of the Y-end flange. The Y-end flange has an outer diameter smaller than a diameter of the valve body, wherein the cooperating holes and studs of the first set comprise Y-end holes spaced radially between the outer diameter of the Y-end flange and a projection of a diameter of the valve cavity bore.

Preferably in the first embodiment, the main leg and Y legs are integrally formed with the main body of the Y-block, e.g., where the Y-block is monolithic. Each Y leg may be coaxial with the valve cavity bore and an annular space may be defined around the central portion between the Y-end flange and the main body. The studs of the first set penetrate the valve body in threaded engagement therewith and are axially retractable into the annular space. A depth of the penetration into the valve body is less than an axial distance through the annular space from ends of the studs to the main body such that the studs can be completely retracted into the annular space to disengage the Y-end flange from the valve body and move the valve body laterally with respect to the Y-end flange. Preferably, a total length of the studs may exceed a total axial distance between the Y-end flange and the main body, since it is desired to reduce the length of any dead space in the Y-legs and the studs can be placed through the holes in the Y-end flange before the valve body is positioned for attachment. In a second embodiment, in one or preferably both ball valves, the first attachment flange also serves as the Y-end flange and wherein the at least one set of cooperating valve holes and studs removably secures the first attachment flange to the valve body. That is, the first attachment flange is the Y-end flange of the Y-block and is integrated into the ball valve by supporting the first annular seat recess at the inner end of the annular axial extension received in the valve cavity bore. This embodiment thus provides a Y-pattern valve assembly comprising: a Y-block comprising a main body, a main leg and two Y legs connected to the main body, wherein the Y legs have respective Y-end flanges removably mated directly with valve bodies of respective ball valves, wherein the Y legs comprise central portions between the Y-end flanges and the main body having a smaller outside diameter relative to lateral dimension of the relatively enlarged main body; and process fluid flow passages through the main leg, Y legs, and ball valves. One or preferably both ball valves comprise: a flow control element received in a valve cavity bore formed in the valve body to selectively allow or block the process fluid flow through the valve cavity bore; first and second annular seat recesses separately receiving fixed and spring-driven seats having spherical surfaces engaging respective spherical surfaces on opposite sides of the flow control element; wherein the Y-end flange is a first attachment flange of first end closure-connect that includes a first annular axial extension from the first attachment flange received in the valve cavity bore. The first annular seat recess is formed in an inner end of the first annular axial extension. A set of cooperating valve holes and studs removably secures the first attachment flange to the valve body. The second annular seat recess is formed opposite the Y-block in a coaxial annular shoulder formed around the valve cavity bore in the valve body or in an inner end of a second annular axial extension from a second attachment flange of a second end closure-connect.

In this embodiment, the deadleg length can be further reduced relative to the first embodiment, but at the expense of slightly increasing the weight of the Y-block with the integral end closure-connect. Moreover, a transverse purge bore can be provided through the Y-end flange into the dead leg area, and the associated ball valve can be in closed position during purging of dead leg area to improve purge efficiency. Additionally, since the first annular seat recess is readily serviceable, it preferably supports the more critical fixed seat and allows flexibility in design to position the fixed seat in the first annular seat recess on either side of the ball valve. Alternatively, where the first and second annular seat recesses are equally serviceable, the design allows flexibility to position the fixed seat in either one of the seat recesses.

In a third embodiment, the second end closure-connect is not present and the second annular seat recess is formed in the valve body in an annular shoulder formed around the process fluid flow passage at one end of the valve cavity bore away from the Y-block. In this variation the second annular seat recess is independent of any end connect.

Thus, the third embodiment provides a Y-pattern valve assembly comprising: a Y-block comprising a main body, a main leg and two Y legs connected to the main body, wherein the Y legs have respective Y-end flanges removably mated directly with valve bodies of respective ball valves, wherein the Y legs comprise central portions between the Y-end flanges and the main body having a smaller outside diameter relative to lateral dimension of the relatively enlarged main body; and process fluid flow passages through the main leg, Y legs, and ball valves. One or preferably both ball valves comprise: a flow control element received in a valve cavity bore formed in the valve body to selectively allow or block the process fluid flow through the valve cavity bore; first and second annular seat recesses separately receiving fixed and spring-driven seats having spherical surfaces engaging respective spherical surfaces on opposite sides of the flow control element; an end closure-connect comprising the Y-end flange as an attachment flange and an annular axial extension from the attachment flange received in the valve cavity bore. The first annular seat recess is formed in an inner end of the annular axial extension. A set of cooperating valve holes and studs removably secures the first attachment flange to the valve body. The second annular seat recess is formed opposite the Y-block in a coaxial annular shoulder formed around the valve cavity bore in the valve body at one end of the valve cavity bore away from the Y-block (preferably wherein the fixed seat is received in the first annular seat recess and the spring-driven seat is disposed in the second annular seat recess).

In this embodiment, the ball valve body preferably comprises an integral valve end connect opposite the Y-block, such as a clamping hub. This embodiment has the advantage of facilitating valve body fabrication using conventional techniques, facilitating fabrication and assembly. This embodiment also has the advantage relative to the other embodiments, of eliminating one bolted joint per ball valve assembly, as well as the potential leak paths and flow turbulence otherwise associated with the eliminated joint. This version is also advantageous when it is desired to locate the more critical fixed seat adjacent to the Y-block, because it is readily serviceable there, e.g., on the low pressure side of the ball when the Y-pattern valve assembly is used where the process fluid in the Y-block is maintained at a lower pressure than in a processing leg or other piping isolated from the process fluid in the Y-block by a closed one of the ball valves, such as the outlet side in a parallel pathway apparatus.

In a fourth embodiment, the second end closure-connect is present and includes a second attachment flange and a second set of cooperating valve holes and studs (preferably in addition to the studs and holes from the first set) sealingly secures the second attachment flange to the valve body, wherein the valve cavity bore receives the second annular axial extension.

This embodiment thus provides a Y-pattern valve assembly, comprising: a Y-block comprising a main body, a main leg and two Y legs connected to the main body, wherein the Y legs have respective Y-end flanges removably mated directly with valve bodies of respective ball valves, wherein the Y legs comprise central portions between the Y-end flanges and the main body having a smaller outside diameter relative to lateral dimension of the main body; process fluid flow passages through the main leg, Y legs, and ball valves; and first sets of cooperating Y-end holes and studs removably securing the Y-end flanges to the valve bodies. One or both ball valves comprise: a flow control element rotatably received in a valve cavity bore formed in the valve body to selectively allow or block flow of the process fluid through the valve cavity bore; a first end closure-connect comprising the Y-end flange as a first attachment flange and a first annular axial extension from the Y-end flange received in the valve cavity bore; a second end closure-connect comprising a second attachment flange and a second annular axial extension from the attachment flange received in the valve cavity bore; a second set of cooperating valve holes and studs sealingly securing the second attachment flange to the valve body (preferably wherein the second set is in addition to the first set); first and second annular seat recesses formed in inner ends of the respective first and second annular axial extensions separately receiving fixed and spring-driven seats having spherical surfaces engaging respective spherical surfaces on opposite sides of the flow control element.

This embodiment has the advantage of providing the ball valve in three pieces, the valve body and second end closure-connect of which are smaller and lighter than the valve body of the first and second embodiments discussed above. Additionally, this embodiment provides a removable rear end cap since the second end closure-connect can be removed from the valve body for ease of entry and serviceability, allowing removal of the more critical fixed seat for servicing apart from the Y-block regardless of whether it is positioned in either side of the flow control element relative to the Y-block. Thus, this configuration has the advantage of facilitating the location of the spring-driven and fixed seats on either side of the flow control valve, such as providing the spring-driven seat on the normally high pressure side of the ball, providing the flexibility to be configured for use on the high pressure and low pressure sides of a process, e.g., in a parallel pathway process with redundant pressure letdown valves where a first Y-pattern valve assembly is used for a relatively high pressure process inlet side upstream from the respective letdown valve with the fixed seat opposite the ball valve from the Y end, and for a relatively low pressure process outlet side downstream from the letdown valve with the fixed seat positioned between the ball valve and the Y end.

In another aspect, a method comprises selectively operating the flow control elements in the valves between opened and closed position for fluid flow or isolation. In embodiments, the flow control elements may be operated independently for simultaneous or sequential operation. In a preferred embodiment, a method of operating the Y-pattern valve assembly described above comprises selectively operating the flow control elements in the ball valves between opened and closed positions for process fluid flow through one or both ball valves and blocking the process fluid flow through one or both ball valves.

In another embodiment, a method of operating the Y-pattern valve assembly of any one of the second, and third embodiments described above comprises selectively operating the flow control element in the ball valves between opened and closed positions for process fluid flow through one or both ball valves and blocking the process flow through one or both ball valves, and supplying purge fluid through purge bores formed in the Y-end flanges to purge the process fluid flow passages in the respective Y legs. This embodiment preferably comprises independently rotating the flow control element of the ball valves from an open position to a closed position and supplying the purge fluid through the purge bores of the ball valves to purge the process fluid flow passage during and/or after the rotation of the respective flow control element to the closed position.

In another embodiment, a method of operating the Y-pattern valve assemblies of any one of the first, second, and third embodiments comprises positioning a first one of the Y-pattern valve assemblies in first location in a process, such as, for example, an inlet side of a redundant pathway process; positioning a second one of the Y-pattern valve assemblies in a second location of the process, such as, for example, an outlet side of the redundant pathway process, wherein the first location (e.g., inlet side) is normally at a higher pressure than the second location (e.g., outlet side); serviceably positioning the fixed seats in the ball valves of the first and second Y-pattern valve assemblies on normally low pressure sides with respect to the flow control elements, such as, for example, opposite the Y ends in the first Y-pattern valve assembly and adjacent the Y ends in the second Y-pattern valve assembly; and selectively operating the flow control elements in the ball valves in the first and second Y-pattern valve assemblies between opened and closed positions for process fluid flow through one or both ball valves and blocking the process fluid flow through one or both ball valves.

Preferably, in the method of operating the Y-pattern valve assemblies just described, the first Y-pattern valve assembly comprises the Y-pattern valve assembly according to one of the first and third embodiments described above wherein the fixed seat is opposite the Y-block, and the second Y-pattern valve assembly comprises the Y-pattern valve assembly according to one of the second and third embodiments described above wherein the fixed seat is adjacent the Y-block, e.g., wherein the first Y-pattern valve assembly comprises the Y-pattern valve assembly according to the first embodiment wherein the fixed seat is opposite the Y-block, and wherein the second Y-pattern valve assembly comprises the Y-pattern valve assembly according to the second embodiment described above wherein the fixed seat is adjacent the Y-block, or alternatively wherein the first and second Y-pattern valve assemblies comprise the Y-pattern valve assembly according to the third embodiment described above wherein the fixed seat is opposite the Y-block in the first Y-pattern valve assembly, and wherein the fixed seat is adjacent the Y-block in the second Y-pattern valve assembly.

### BRIEF DESCRIPTION OF THE DRAWINGS

FIG. 1 is a perspective view of a Y-pattern valve assembly according to an embodiment of the present invention with stem adaption shown on the left and a bare stem on the right.

FIG. 2 is a plan sectional view of the Y-pattern valve assembly of FIG. 1.

FIG. 3 is a vertical cross-sectional view of the Y-pattern valve assembly of FIGS. 1-2.

FIG. 4 is an enlarged view of the spring-driven seat detail from FIG. 3.

FIG. 5 is an enlarged view of the fixed seat detail from FIG. 3.

FIG. 6 is an enlarged view of the Y-end connect/body bolted joint detail of FIG. 3.

FIG. 7 is an enlarged view of the stem/stem packing/actuator adaption detail from FIG. 3.

FIG. 8 is a perspective view of a cross-sectional plan view of a Y-pattern valve assembly according to another embodiment with stem adaption shown on the left and a bare stem on the right.

FIG. 9 is a plan sectional view of the Y-pattern valve assembly of FIG. 8.

FIG. 10 is a vertical section through one of the valves of the Y-pattern valve assembly of FIGS. 8-9.

FIG. 11 is a perspective view of a Y-pattern valve assembly according to another embodiment with stem adaption shown on the left and a bare stem on the right.

FIG. 12 is a plan sectional view of the Y-pattern valve assembly of FIG. 11 with an open valve shown on the left and a closed valve on the right wherein the fixed seat is located opposite the Y-ends.

FIG. 13 is a vertical section through one of the valves of the Y-pattern valve assembly of FIGS. 11-12 wherein the fixed seat is located adjacent the Y-ends.

### DETAILED DESCRIPTION

### Definitions

As used herein, the term “assembly” refers to the fitting together of manufactured parts into a generally complete machine, structure, or unit of a machine, or a collection of parts so assembled.

As used herein, the terms “ball” and “flow control element” of a ball valve are used interchangeably in reference to an at least partially spherical plug having a flow bore therethrough which can be rotated to allow or block fluid flow.

As used herein, the term “ball valve” refers to a valve having a generally spherical flow control element disposed in a flow bore through a body of the valve that can be rotated to align (“open”) or un-align (“closed”) a bore through the flow control element with the flow bore through the valve body.

As used herein, the term “bore” refers to a hole or passage made by or as if by use of a drill.

As used herein, the term “clamping hub” refers to a flanged hub suitable for sealingly clamping to a similarly flanged hub of adjoining piping, e.g., pipe, pipe fitting or other component.

As used herein, a “closed position” of a flow control element refers to a flow control element having a flow bore rotated to inhibit or prevent fluid communication with the flow bore of a valve.

As used herein, a “delta gasket” refers to an annular gasket made from a seamless ring and having a splined profile with a peak-to-peak dimension just slightly greater than a sum of the opposing seal groove dimensions.

As used herein, the term “end connect” refers to a connecting component for a pipe fitting such as a valve that is removably or permanently attached at a first end proximal to the fitting and has a connection profile at a second end away from the fitting, such as a welding profile or flange such as a clamping hub, for preferably removable attachment to downstream or upstream piping or fittings. As used herein, the term “end closure-connect” refers to an end connect for a valve that is sealingly and removably connectable to a flow passage opening from an end of the valve body and seats or supports a seat for the flow control element. The end closure-connect may include a flanged end connection such as a clamping hub for removable attachment to downstream or upstream piping or fittings or may have a connection profile to be permanently attached to the piping or fitting, as by welding.

As used herein, a “flange” refers to a rib or rim for strength, for guiding, or for attachment to another object.

As used herein, a “hub” refers to the central part of a circular object (such as a wheel or propeller).

As used herein, an “open position” of a flow control element refers to a flow control element having a flow bore wholly or partially aligned for fluid communication with the flow bore of a valve.

As used herein, the terms “outer” and “inner” used in connection with ball valve components refer to positions or items disposed axially away from and near or towards the flow control element, respectively; or to positions or items disposed radially away from and near or towards an axis of the flow bore, respectively.

As used herein, a “seal” refers to a tight and perfect or nearly perfect closure (as against the passage of gas or water).

As used herein, a “seat” refers to a part of the valve in contact with the flow control element for forming a fluid tight seal or for urging the flow control element against a seal-forming seat. A “fixed seat” refers to a seat held between the flow control element and the valve body so that it does not normally move relative to the valve body and flow control element, whereas a “spring-driven seat” refers to a seat biased by a spring.

As used herein, a “valve body” refers to the main, central, or principal part of a valve generally housing the flow control element.

As used herein, a “valve cavity” refers to the space in a valve body receiving the flow control element; also, the space between an interior surface of the main passage or bore of the valve body and the flow control element. The outer surface of the valve cavity is often formed as a main bore in the valve body.

As used herein, the term “Y-block” refers to a pipe element or fitting having three legs which serve as ports or inlets/outlets, such as a tee or wye, and especially having the shape of the letter Y. The “main leg” of a Y-block refers to a leg which is at an oblique angle with respect to the other legs, whereas the “auxiliary legs” lie at an oblique angle with respect to the main leg and form an acute angle between the auxiliary legs.

### Embodiments

In one aspect the present invention provides a Y-pattern valve assembly. The assembly has a Y-block, that is preferably monolithic, having a main leg and two preferably integral Y legs each with Y-end flanges that are connected to valve bodies of respective ball valves, preferably severe service ball valves. Process fluid flow passages are formed through the main leg, Y legs, and ball valves, respectively. A first set of cooperating Y-end holes and studs removably secures the Y-end connect flanges to the valve bodies. The ball valves each comprise a flow control element received in a valve cavity bore formed in the valve body, fixed and spring-driven seats having spherical surfaces for sealingly engaging a flow control element, first and second annular seat recesses to separately receive the seats, and at least a first end closure-connect for the valve body.

The Y legs preferably comprise central portions between the Y-end flanges and a main body of the Y-block having a smaller outside diameter relative to lateral dimension of the relatively enlarged main body.

The first end closure-connect comprises an attachment flange for attaching the first end closure-connect to the valve body, an end connect on one side of the attachment flange, and an annular axial extension on the other side of the attachment flange. The annular axial extension is received in the valve cavity bore and has the first annular seat recess formed in an inner end of the axial extension, i.e., adjacent to the flow control element, and one of the fixed or spring-driven seats is disposed in the first annular seat recess. The cooperating holes and studs are preferably tapped and threaded.

The Y-end flanges of the Y-block, which may be or comprise the attachment flanges of the first end closure-connect or may be separate from the first end closure-connect attachment flanges, mate directly with the respective valve bodies of the ball valves. The valve bodies preferably have matching tapped holes to receive studs and secure the Y-end flanges and/or, if different, the attachment flanges of the first end closure-connect to the valve bodies.

In an embodiment, the valve body of at least one of the ball valves, i.e., one or preferably both, forms an annular shoulder around a flow passage at an end of the valve cavity bore adjacent to the Y-end connect flange of the Y-block. The first end closure-connect is disposed in the other end of the valve cavity bore, i.e., on the other side of the flow control element from the Y-block. The fixed seat is preferably disposed in the first annular seat recess formed in an inner end of the axial extension of the first end closure-connect. The spring-driven seat is preferably disposed in the second annular seat recess formed in the valve body at the shouldered end of the valve cavity bore, i.e., adjacent to the Y-block. In this embodiment, an adjacent Y-end flange of the Y-block is connected directly to the valve body, independently of the seat recesses, i.e., it is not an end closure-connect. Thus, the annular shoulder is disposed between the flow control element and the Y-end flange, spacing the Y-end flange from the second annular seat recess, which is independent of the Y-end flange.

Preferably, the Y-end connect flange has an outside diameter that is less than an outside diameter of the respective valve body. The cooperating holes and studs of first sets comprise Y-end holes spaced radially between the outer diameter of the Y-end flange and a projection of a diameter of the valve cavity bore. Second sets of cooperating valve holes and studs removably secure the attachment flanges of the first end closure-connects to the valve bodies.

Preferably, the main leg and Y legs are integrally formed with the main body of the Y-block. For example, the Y-block can be monolithic, or formed by machining the elements from a single metal block. Each Y leg can be coaxial with the valve cavity bore. The central portion can define an annular space around the central portion between the Y-end flange and the main body. The studs attaching the Y-end flange can thread into holes tapped in the valve body and can conveniently be axially retractable into the annular space around the Y leg. The space between the Y-end flange and the main body of the Y-block should be sufficient to allow full retraction of the studs from the valve body so that the valve body can be disengaged and moved laterally away from the Y-end flange. On the other hand, to reduce the dead length in the Y legs, the studs could be inserted through the holes in the Y-end flange before placing the valve body for attachment if the annular space around the Y legs is not large enough for lateral placement.

A first gasket may be provided to form a seal between the valve body and the Y-end flange and/or the attachment flange of the end closure-connect, and a second gasket between the valve body and the first end closure-connect. For example, delta gaskets can be received in opposing seal grooves formed in the valve body and Y-end flange at a periphery of the fluid flow passage, and in opposing, adjoining circumferential sealing grooves formed in the valve body and the attachment flange adjacent an outside diameter of the first annular axial extension.

If desired, the end closure-connects of the ball valves can comprise a clamping hub opposite the axial extension, e.g., to provide a port for connection to downstream (or upstream) piping.

In this embodiment, the spring-driven seat of the at least one ball valve can be biased by at least one spring adjacent the seat recess of the valve body, and the fixed seat can sealingly engage the first end closure-connect at an annular raised face. Preferably, the spring-driven seat is biased by an inner spring in an inner spring pocket formed about the flow bore in the valve body adjacent an inside diameter of the spring-driven seat and biasing an end surface of the spring-driven seat, and an outer spring in an outer spring pocket formed adjacent an outside diameter of the spring-driven seat and biasing an outwardly-extending flange on the spring-driven seat. Preferably, the raised face of the at least one ball valve is formed on the first end closure-connect and the fixed seat is tightly biased against the raised face by a seat locking ring engaging an outer radial edge of the fixed seat and secured to the first end closure-connect by a plurality of radially spaced threaded members.

In another embodiment, the Y-end flange is an end closure-connect attachment flange. One of the spring-driven and fixed seats is disposed in the end closure-connect/Y-end connect flange seat recess, and the other of the spring-driven and fixed seats is disposed in an annular seat recess formed in the valve body at the shouldered end of the valve cavity bore, i.e., on the other side of the flow control element from the attachment/Y-end flange. Preferably, the valve body comprises a clamping hub adjacent to the shouldered end of the valve cavity bore, e.g., to provide a port for connecting the flow passage to downstream or upstream piping. Preferably, a transverse purge bore is provided through the first end closure-connect flange of the at least one ball valve to a flow passage in the respective Y leg.

If desired, the fixed seat can be disposed in the first annular seat recess formed on the end of the annular axial extension, and the spring-driven seat in the second annular valve seat recess formed in the valve body. In this embodiment, the spring-driven seat is axially biased by at least one spring, and the fixed seat sealingly engages the annular axial extension of the first end closure-connect at a raised face, as described above. As described above, the spring-driven seat can be biased by inner and outer springs; and/or the raised face can be biased against the raised face by a seat locking ring secured to the first end closure-connect by the plurality of radially spaced threaded members.

Alternatively, the spring-driven seat is disposed in the first annular seat recess on the axial extension, and the fixed seat in the second seat recess in the valve body. Here, the spring-driven seat can be biased by at least one spring, e.g., the inner and outer springs as described above adjacent the end closure-connect seat recess, and the fixed seat biased against the raised face by the seat locking ring as described above secured to the valve body by a plurality of radially spaced threaded members.

In another embodiment, the first attachment flange of the first end closure-connect of at least one of the ball valves is one of the Y-end flanges of the Y-block and is connected to the valve body at an end of the valve cavity bore. The at least one ball valve comprises a second end closure-connect at the other end of the fluid flow passage. The second end closure-connect comprises: an attachment flange; an annular axial extension from one side of the attachment flange received in the valve cavity bore and having the second annular seat recess formed in an inner end thereof; and preferably an end connect on the other side of the attachment flange away from the valve body, which preferably comprises an end connect flange such as a clamping hub. Another set of cooperating holes and studs secures the second attachment flange to the valve body. One of the spring-driven and fixed seats is disposed in the first annular seat recess formed in the first end closure-connect and the other of the spring-driven and fixed seats is disposed in the second annular seat recess formed in the second end closure-connect. Preferably, a transverse purge bore is provided through the first attachment/Y-end flange of the at least one ball valve to the fluid flow passage in the respective Y leg of the Y-block.

If desired, the fixed seat can be disposed in the first annular seat recess in the first end closure-connect, and the spring-driven seat in the second annular seat of the second end closure-connect. Here, the spring-driven seat can be biased as described above by at least one spring or preferably the inner and outer springs, and also as described above the fixed seat can sealingly engage the annular raised face which here is formed in the first annular seat recess on the first end closure-connect and biased against the raised face by a seat locking ring engaging an outer radial edge of the fixed seat and secured to the annular axial extension of the first end closure-connect by a plurality of radially spaced threaded members.

Alternatively, the spring-driven seat can be disposed in the first annular seat recess, and the fixed seat in the second annular seat recess.

In any embodiment, the main leg of the Y-block can comprise a clamping hub; and/or the Y legs can comprise central portions between the Y-end flanges and a main body of the Y-block that have a smaller outside diameter relative to a lateral dimension of the main body. Alternatively, or additionally, gaskets, preferably delta gaskets, are disposed in opposing sealing grooves formed between the valve bodies and adjacent Y-end flanges, first attachment flanges if different, and/or second attachment flanges, if present.

In another aspect, the present invention provides a method of operating the Y-pattern valve assembly of any embodiment described above. The method comprises selectively operating the flow control elements in the valves between opened and closed position for fluid flow or isolation.

In a preferred embodiment of the method, the first attachment flange of at least one of the ball valves is the Y-end flange, and comprises a transverse purge bore to a flow passage in the respective Y leg of the Y-block. The method can comprise an additional step of supplying a purge fluid through the purge bore to purge the flow passage, preferably while closing the respective ball valve while supplying the purge fluid or supplying the purge fluid after closing or while the ball valve is closed.

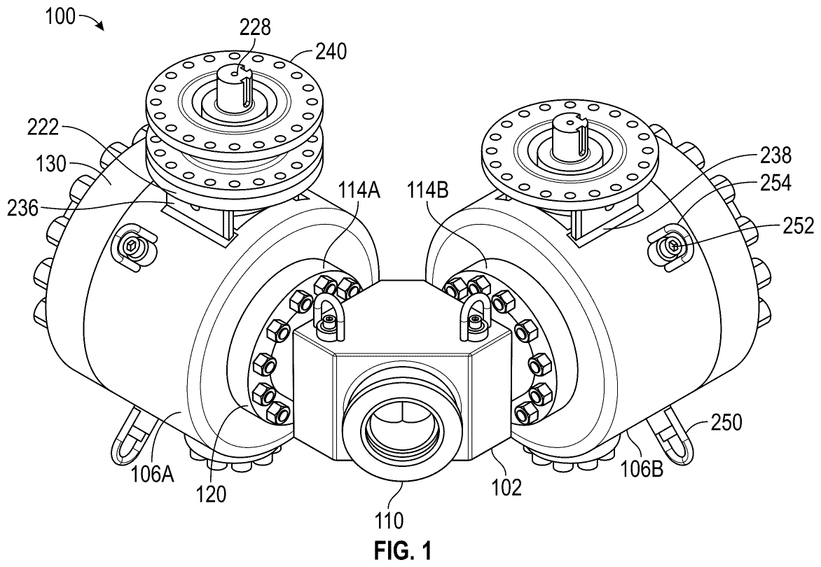

With reference to the drawings in which like parts have like reference numerals, FIGS. 1-7 show a Y-pattern valve assembly 100 according to an embodiment of the present invention wherein the Y-block 102 is connected directly to the valve bodies 104 of the valves 106A, 106B. Y-block 102 has a main body 108, main open flanged leg 110, a flow passage 112, and two Y legs 114A, 114B, with respective ball valves 106A, 106B, which can desirably be severe service ball valves, connected thereto. Flow passage 112 generally provides process fluid egress through the legs 110, 114A/B, and the body 108, and is preferably formed as bores coaxial with the respective legs 110, 114A/B.

In any embodiment, legs 114A, 114B of the Y-block 102 preferably have a central portion 118 between the Y-end flanges 120 and main body 108 that has a smaller outside diameter relative to a dimension of the main body 108 and/or the flanges 120.

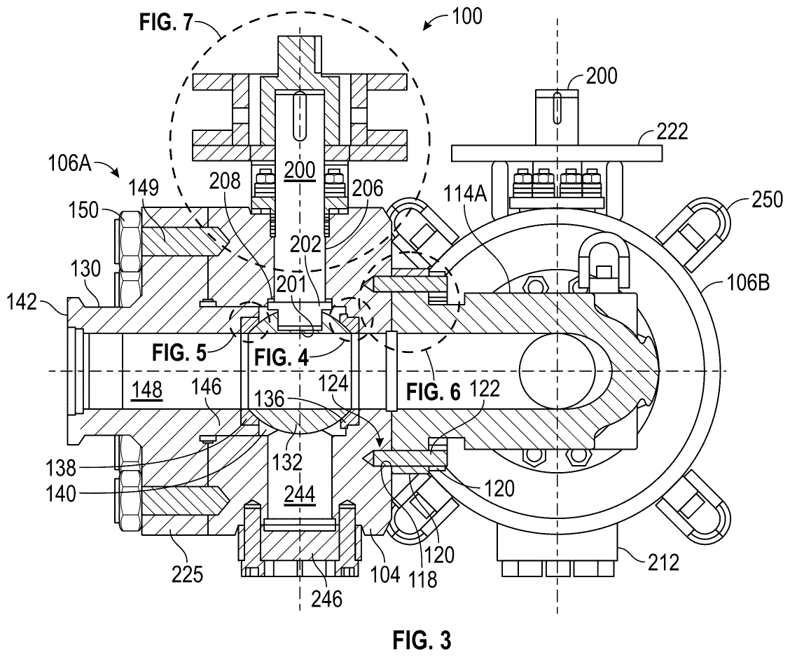

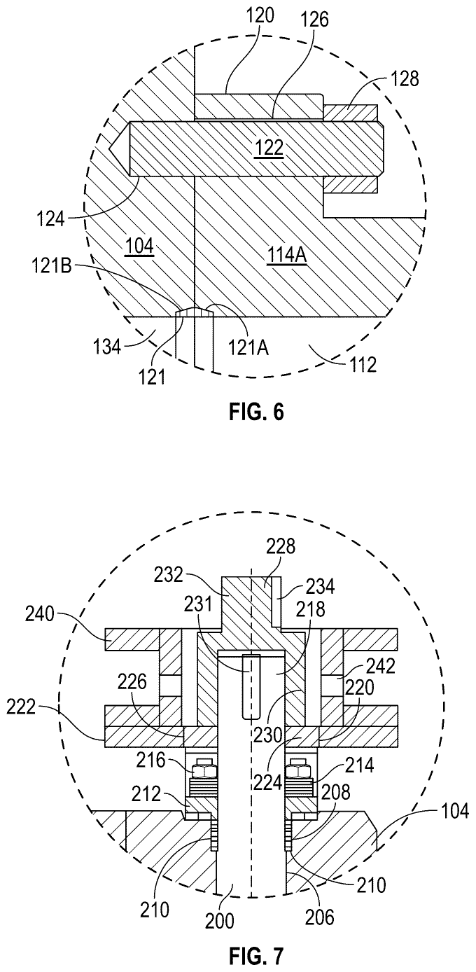

In this embodiment, the flanges 120 of the legs 114A, 114B are connected directly to the valve bodies 104 via studs 122 received in bores 124 in the valve body, e.g., threadedly, which pass through bores 126 in the flanges 120 and are secured with nuts 128, as best seen in FIGS. 3 and 6. It can be seen that the studs 122 are generally disposed along a bolt circle larger than a diameter of the flow passage 112 and are located within the outer diameter of the flanges 120. The studs 122 can be advanced into or retracted from the bores 126 by using a wrench on the nuts 128 in the space adjacent to the narrowed central portion 118 between the flanges 120 and the enlarged main body 108. Thus, by removing the clamp from the clamping hub 144, and disengaging a valve body 104 from the flange 120 by retracting the studs 122, the valve body 104 can be removed laterally without any other disconnection or removal of the Y-block 102 or other piping.

Gasket 121, which may be a delta gasket, can be used to provide a seal at the joint, as best seen in FIG. 6. For example, gasket 121 can be received in opposing seal grooves 121A, 121B formed in the flange 120 and valve body 108 adjacent to a periphery of flow bores 112, 134.

The Y legs 114A, 114B are as short as possible but should be just sufficiently long to allow a wrench to access the nuts 128 between the studs 122 and main body 108.

The valves 106 each have valve body 104 connected to an end closure-connect 130, a spherical flow control element 132 positioned in the flow bore 134, a spring-driven pusher seat 136, a fixed seat 138, and a stem 170. The flow control element 132 floats between seats 136, 138. Normally, but not always, the spring-driven seat 136 is positioned on the upstream or high-pressure side of the valve 106, and the fixed seat 138 on the downstream or low-pressure side where the spring-driven seat urges the flow control element 132 against the fixed seat 138 to form the primary seal. This arrangement is useful when the process fluid flow is usually from the Y-block 102 into the valves 106. This arrangement facilitates serviceability of the downstream fixed seat 138 since it is accessible by removing the first end closure-connect 130. Alternatively, the positions of seats 136, 138 could be interchanged.

The valve body 104 has a central cavity bore 140 with a diameter sufficient to receive the flow control element 132. The end closure-connect 130 preferably comprises a clamping hub 142 suitable for clamping to a pipe or piping component (not shown) provided with a similar hub. The end closure-connect 130 has an attachment flange 144 located at an outer end of an axial extension 146 into the valve cavity bore 140 and is removably connected to the valve body 104. A flow bore 148 is formed through the axial extension 146, flange 144 and clamping hub 142.

The attachment flange 144 may be secured to the valve body 104 by means of studs 149 and nuts 150 and sealed with a gasket 152 positioned in opposing seal grooves 154A, 154B formed in an inner surface of the flange 144 adjacent to an outside diameter of the axial extension 146 and in an outer surface of the valve body 104 adjacent to an inside diameter of the valve cavity bore 140. The seat recess 156 is formed in the inner end of the axial extension 146.

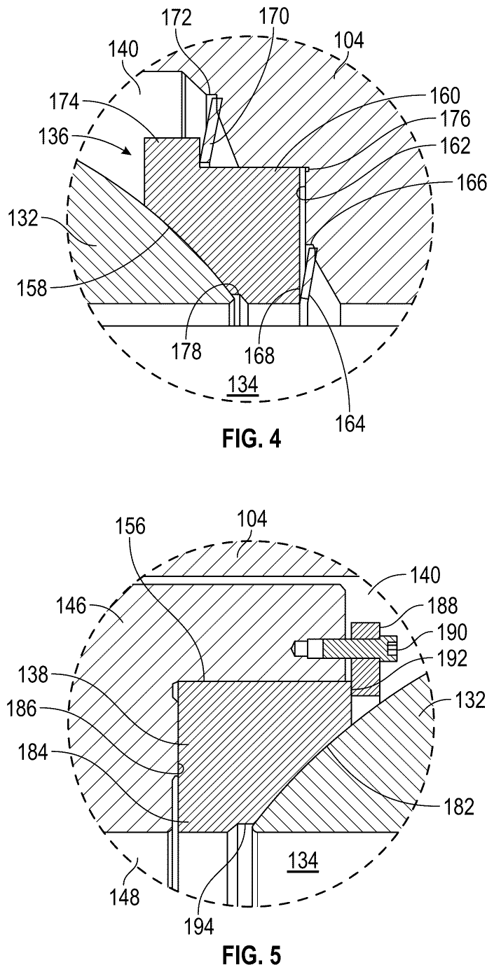

The spring-driven seat 136 detail from FIG. 3 is shown in FIG. 4. The seat 136 is disposed in an annular seat recess 162 formed in an outer end of the cavity bore 140 of the valve body 104 adjacent to the Y-block 102. Seat 136 has a spherical surface 158 for engaging the flow control element 132, preferably sealingly engaging the flow control element 132. An outer end 160 of seat 136 is received in a seat recess 162 formed in the valve body 104. The seat 136 is spring-driven by at least one spring, e.g., a Belleville spring, disposed between the seat and the valve body 104, preferably at least two springs, e.g., an inner load spring 164 disposed in inner spring pocket 166 biasing an outer surface 168 of the seat 136 adjacent an inside diameter thereof, and an outer Belleville load spring 170 disposed in outer spring pocket 172 biasing an annular shoulder such as a surface on an outwardly extending flange 174 of the seat 136 adjacent an outside diameter thereof. If desired, a relief recess 176 may be formed in seat recess 162 adjacent an outer diameter thereof. A chamfered recess 178 may be formed adjacent spherical surface 158 at an inside diameter of the flow bore 134 to facilitate smooth rotational sliding of the flow control element 132 at the edges of the flow bore 134.

The fixed seat 138 detail from FIG. 3 is shown in FIG. 5. The seat 138 is disposed in an annular seat recess 156 formed in an inner end of an annular axial extension 146 of the end closure-connect 130 received in the valve cavity bore 140 opposite the Y-block 102. The seat 138 has a spherical surface 182 for sealingly engaging the flow control element 132 and an outer end 184 received in seat recess 156 formed in an inner end of annular axial extension 146 of the end closure-connect 130 and sealingly engaging an annular raised surface 186. A seat locking ring 188 is secured to the annular axial extension 146 by a plurality of radially spaced threaded members 190 to tightly bias an outer radial edge 192 of the seat 138. A chamfered recess 194 may be formed adjacent an inside diameter of the spherical surface 182 to facilitate smooth rotational sliding of the flow control element 132 at the edges of the flow bore 134.

As seen in FIG. 3, the stem 200 has a ball adaptor 202 at a lower end thereof having a non-circular cross-section, e.g., square, or rectangular, engaging a complementarily shaped slot or recess 204 formed in the flow control element 132, by which rotation of the stem 200 turns the flow control element 132 between open and closed positions. If desired, the ball adaptor 202 may be integral with the stem 200 or provided as a separate piece bolted or otherwise attached to the end of the stem. Desirably, the ball adaptor 202 has a larger diameter than stem bore 206 to prevent the stem from blowing out and can be shouldered in annular recess 208 formed in the valve body 104 coaxial with stem bore 206.

FIGS. 1 and 3 show a bare stem 200 on the right-side valve 106B, and the adaption with a stem adaptor 228 and mounting flange adaptor 240 on the left-side valve 106A. The detail of the stem adaption on valve 106A from FIG. 3 is shown in FIG. 7. The stem 200 passes through stem bore 206 formed in valve body 104. Packing rings 208, e.g., five in number, are disposed in packing gland 210 and compressed by gland thruster 212 and live loading springs 214 secured to the valve body 104 by bolts 216. The packing rings 208 may be protected by metal anti-extrusion rings 210 below and/or above the packing rings 208.

The upper end 218 of stem 200 extends adjacent to, into or through a bore 220 formed in laterally spaced bracket 222, which may receive a coaxial stem bushing 224 shouldered in the bore 220 at an upper end 226 thereof. A stem adaptor 228 has a lower end 230 engaging the upper end 218 of the stem 200 by means of a stem key(s) (not shown) received in keyway 231, and an upper end 232 engaging the actuator (not shown) by means of actuator/stem adaptor key(s) (not shown) received in keyway 234.

Bracket 222 can be supported on legs 236 secured to the valve body, e.g., by welding as at 238 (see FIG. 1) or by bolting. The actuator is typically attached to bracket 222 by bolting to a mounting flange adaptor 240 bolted to bracket 222. If desired, the mounting flange adaptor 240 may be provided with one or more bores 242 to receive locking pins (not shown) to prevent inadvertent operation of the valve 106, as described in US 11,174,963.

To facilitate installation of the valve stem 200, valve 106 may optionally be provided with an axially aligned access port 244 that is sealed by an access cover 246 bolted to the valve body 104. This allows insertion of the valve stem 200 through the port 244, into the stem bore 206, and to the bracket bore 220 before the flow control element 132 is installed. Generally, the packing rings 206, anti-extrusion rings 208, gland thruster 212, and springs 214 are installed in the open area between the bracket 222 and the valve body 104 as the stem 200 is inserted to the bracket bore 220, and then the gland thruster 212 is secured to the valve body 104.

Additionally, the Y-block 102 and/or the valves 106 can be provided with pad eyes 250, screws 252 (which may include guards 254) or the like to facilitate lifting, accessory attachment, and so on.

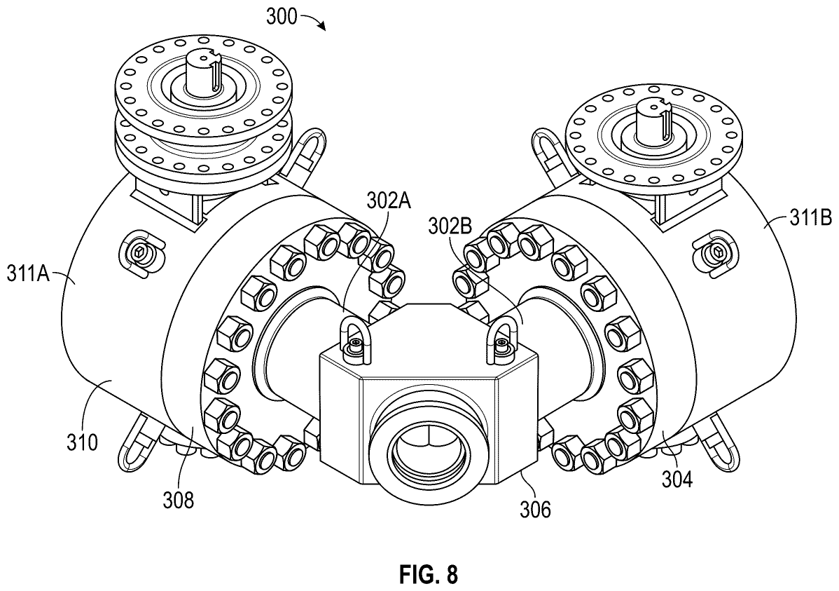

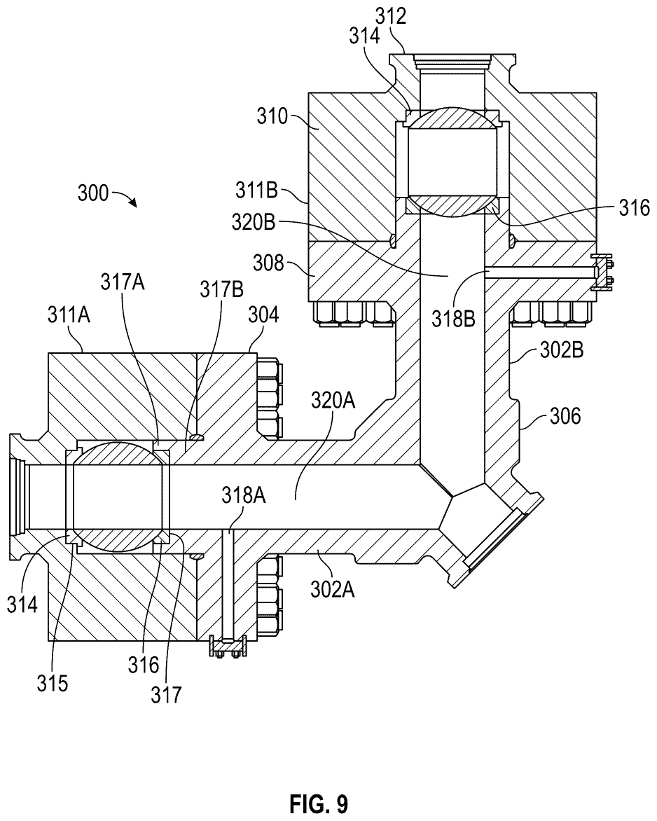

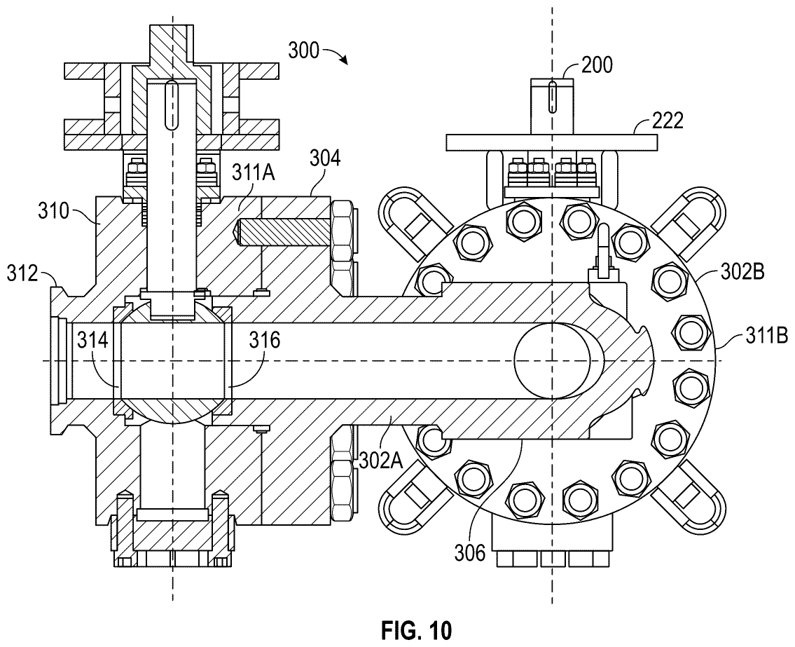

FIGS. 8-10 illustrate another embodiment of the invention where the Y-pattern valve assembly 300 comprises Y legs 302A, 302B having Y end closure-connects 304 integral with the Y-block 306 having Y-end flanges 308 similar to Y-end flanges 120 in FIGS. 1-7. In this embodiment, the Y-end flanges 308 of the end closure-connects 304 preferably have the same diameter as the valve bodies 310 and are bolted directly thereto. The bodies 310 of the valves 311A, 311B can be provided with clamping hubs 312, as best seen in FIGS. 9-10. This arrangement has the advantage of distributing some of the weight from the valves 311A, 311B into the Y-block 306.

In this embodiment, the fixed seat 316 is preferably positioned in the first annular seats 317 in ends 317A of annular axial extensions 317B of the end closure-connects 304 adjacent to the Y-block 306 and the spring-driven seat 314 is positioned adjacent the clamping hub 312 opposite the Y-block 306 in the second annular seats 315 formed in the valve bodies 310. This arrangement is useful when the process fluid flow is usually from the valves 311A, 311B into the Y-block 306. Alternatively, the positions of seats 314, 316 could be interchanged (not shown).

Additionally, as best seen in FIG. 9, the assembly 300 may be provided with transverse purge bores 318A, 318B through the flanges of end connects 304, 308, respectively. The purge bores 318A, 318B can be used to purge dead leg areas 320A, 320B, preferably when the respective valves 311A, 311B are closed.

The parts and components of the assembly 300 are otherwise identical or similar to those of the embodiment of FIGS. 1-7.

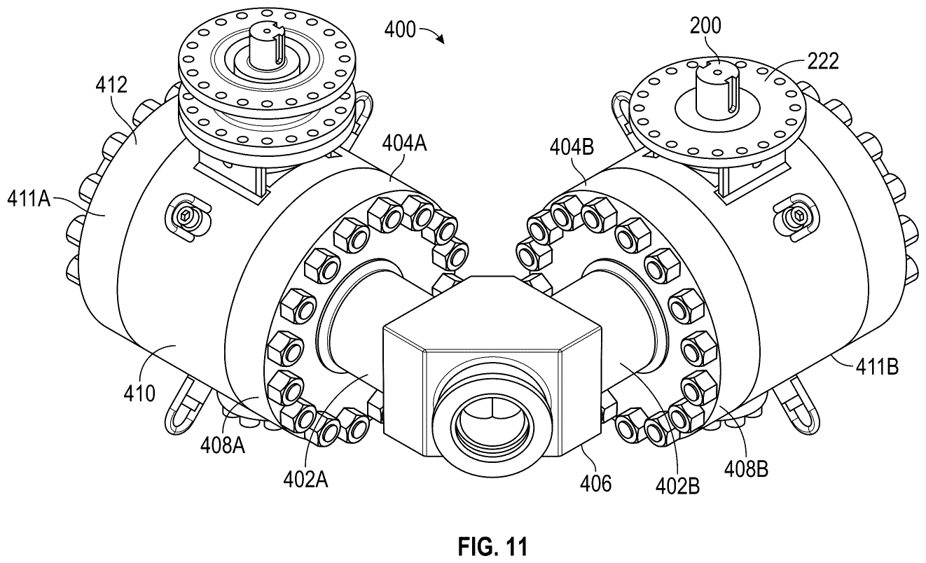

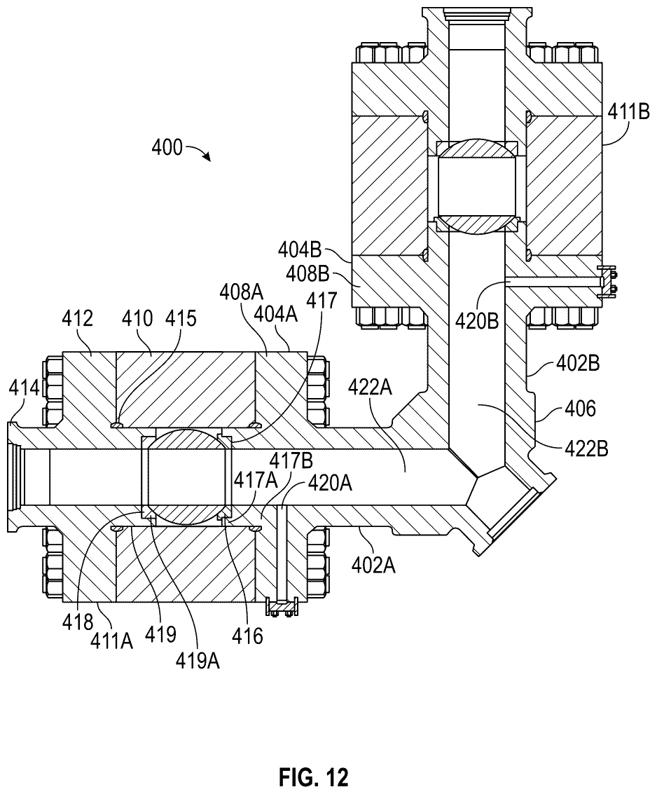

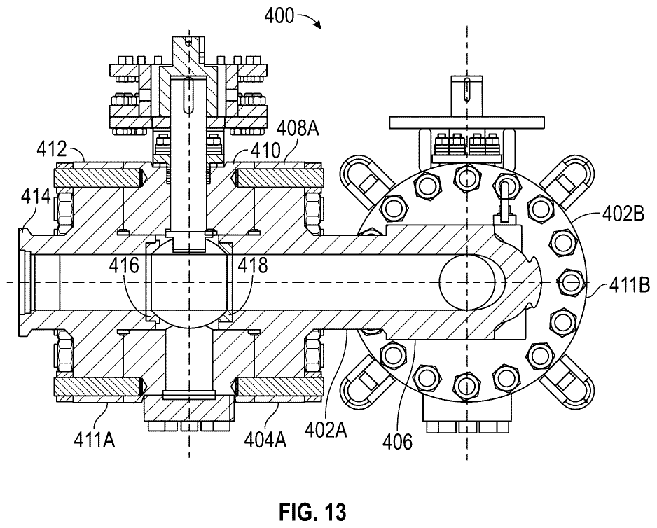

FIGS. 11-13 illustrate another embodiment of the invention where the Y-pattern valve assembly 400 comprises Y legs 402A, 402B having first Y end closure-connects 404 integral with the Y-block 406 as in FIGS. 8-10. In this embodiment, the Y-end flanges 408A, 408B of the first end closure-connects 404A, 404B preferably have substantially the same diameter as the valve bodies 410 and are bolted directly thereto as in FIGS. 8-10. However, the valves 411A, 411B are three-piece assemblies and the valve bodies 410 are connected to second end closure-connects 412 opposite the Y-block 406. The second end closure-connects 412 can be provided with the clamping hubs 414, as best seen in FIGS. 12-13. Gasket 415 identical to gasket 152 in FIGS. 1-10 can provide a seal between the valve body 410 and the second end closure-connect 412.

This arrangement has the further advantage of distributing some of the weight from the valve bodies 410 into the second end closure-connect 412.

In this embodiment, the spring-driven seat 416 can be positioned in either the first annular seats 417 in ends 417A of annular axial extensions 417B of each of the end closure-connects 404A, 404B (see FIG. 12), or in the annular seats 419 in ends 419A of annular axial extensions 419B of each of the second end closure-connects 412 (see FIG. 13). The fixed seat 418 can be positioned in the other of the annular seats 419 in ends 419A of annular axial extensions 419B of each of the second end closure-connects 412 (FIG. 12) or the first annular seats 417 in ends 417A of annular axial extensions 417B of each of the end closure-connects 404A, 404B (FIG. 13). The arrangement of FIG. 13 is useful when the process fluid flow is usually from the valves 411A, 411B into the Y-block 406, whereas the arrangement of FIG. 12 is useful when the process fluid flow is normally from the Y-block 406 to the valves 411A, 411B.

Additionally, as best seen in FIG. 12, the assembly 400 may be provided with transverse purge bores 420A, 420B through the flanges 408A, 408B of first end closure connects 404A, 404B, respectively. The purge bores 420A, 420B can be used to purge dead leg areas 422A, 422B, preferably when the respective valves 411A, 411B are closed.

The parts and components of the assembly 400 are otherwise identical or similar to those of the embodiments of FIGS. 1-10.

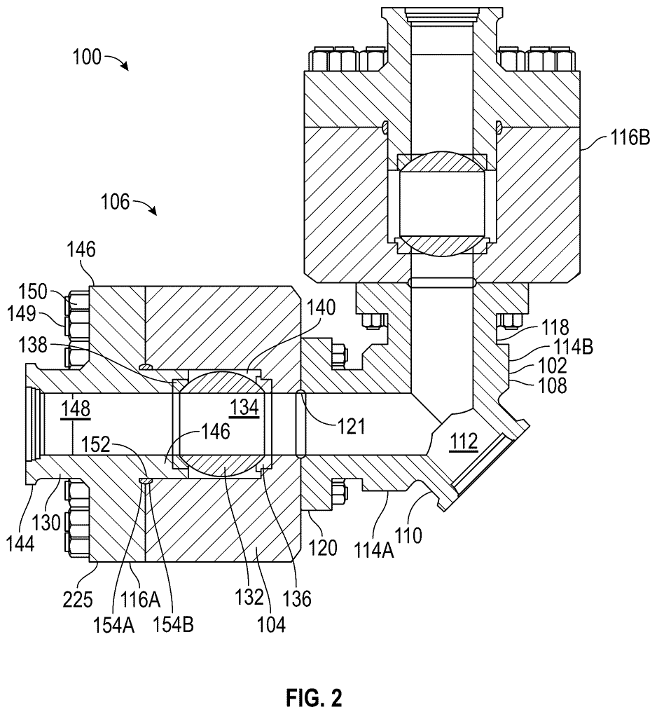

In use, the method of operating the Y-pattern valve assemblies 100, 300, 400 includes selectively operating the flow control elements 132 between opened and closed positions (see FIGS. 2, 9, 12) for process fluid flow through one or both ball valves 106A/106B, 311A/311B, 411A/411B and blocking the process fluid flow through one or both ball valves. For example, FIGS. 2, 9, and 12 generally show the A valves open and the B valves closed. Where the purge bores 320A/320B (FIGS. 8-10) and 420A/420B (FIGS. 11-13) are present the method can also include supplying purge fluid through the purge bores to purge the respective dead legs 322A/322B, 422A/422B in the process fluid flow passages 112, preferably while closing or after closing the adjacent ball valves 311A/311B, 411A/411B.

Another method of operating the Y-pattern valve assemblies 100, 300, 400 comprises including positioning a first one of the Y-pattern valve assemblies 100, 300, 400 in a first location in a process, such as an inlet side of a redundant pathway process; positioning a second one of the Y-pattern valve assemblies in a second location of the process, such as an outlet side of the redundant pathway process, wherein the first location (inlet side) is normally at a higher pressure than the second location (outlet side), substantially as shown in FIGS. 7-8 of the '347 patent mentioned above, i.e., in a redundant or parallel path process or apparatus. The method also comprises serviceably positioning the fixed seats in the ball valves of the first and second Y-pattern valve assemblies on normally low pressure sides with respect to the flow control elements (preferably opposite the Y ends in the first Y-pattern valve assembly and adjacent the Y ends in the second Y-pattern valve assembly); selectively operating the flow control elements in the ball valves in the first and second Y-pattern valve assemblies between opened and closed positions for process fluid flow through one or both ball valves and blocking the process fluid flow through one or both ball valves.

For example, in this method the first Y-pattern valve assembly with the high pressure process inlet can comprise the Y-pattern valve assembly 100 of FIGS. 1-7, or the assembly 400 of FIG. 12, wherein the fixed seat is opposite the Y-block; and the second Y-pattern valve assembly with the low pressure process outlet can comprise the Y-pattern valve assembly 300 of FIGS. 8-10 or assembly 400 of FIG. 13 wherein the fixed seat is adjacent the Y-block. Preferably, the first Y-pattern valve assembly comprises the Y-pattern valve assembly 100 according to FIGS. 1-7 and the second Y-pattern valve assembly comprises the Y-pattern valve assembly of FIGS. 8-10 where the fixed seat is opposite the Y-block; or the first Y-pattern valve assembly comprises the Y-pattern valve assembly 400 according to FIG. 12 wherein the fixed seat is opposite the Y-block and the second Y-pattern valve assembly comprises the Y-pattern valve assembly of FIG. 13 where the fixed seat is adjacent the Y-block.

### Embodiments Listing

Accordingly, the present invention provides the following Embodiments:
Embodiment 1: A Y-pattern valve assembly that includes: a Y-block comprising a main body, a main leg and two Y legs connected to the main body, wherein the Y legs have respective Y-end flanges removably mated directly with valve bodies of respective ball valves, wherein the Y legs comprise central portions between the Y-end flanges and the main body having a smaller outside diameter relative to lateral dimension of the relatively enlarged main body. There are process fluid flow passages through the main leg, Y legs, and ball valves. One or both ball valves include: a flow control element received in a valve cavity bore formed in the valve body to selectively allow or block the process fluid flow through the valve cavity bore. First and second annular seat recesses separately receive fixed and spring-driven seats having spherical surfaces engaging respective spherical surfaces on opposite sides of the flow control element. A first end closure-connect includes a first attachment flange and a first annular axial extension from the first attachment flange received in the valve cavity bore. The first annular seat recess is formed in an inner end of the first annular axial extension. At least one set of cooperating valve holes and studs removably secure the Y-end flanges and/or the first attachment flange to the valve body. The second annular seat recess is formed in a coaxial annular shoulder formed around the valve cavity bore in the valve body or in an inner end of a second annular axial extension from a second attachment flange of a second end closure-connect.
Embodiment 2: The Y-pattern valve assembly of Embodiment 1, wherein the first end closure-connect is disposed opposite the Y-block; the annular shoulder is disposed between the flow control element and the Y-end flange; the second annular seat recess is spaced from and independent of the Y-end flange; and the Y-end flange has an outer diameter smaller than a diameter of the valve body. The cooperating holes and studs of the at least one set comprise Y-end holes spaced radially between the outer diameter of the Y-end flange and a projection of a diameter of the valve cavity bore to secure the Y-end flanges to the valve bodies. Second sets of cooperating valve holes and studs removably secure the attachment flanges of the first end closure-connects to the valve bodies.
Embodiment 2A: A Y-pattern valve assembly that includes a Y-block having a relatively enlarged main body, a main leg and two Y legs connected to the main body, wherein the Y legs have respective Y-end flanges removably mated directly with valve bodies of respective ball valves, wherein the Y legs comprise central portions between the Y-end flanges and the main body having a smaller outside diameter relative to lateral dimension of the main body; process fluid flow passages through the main leg, Y legs, and ball valves, wherein one or both ball valves include a flow control element received in a valve cavity bore formed in the valve body to selectively allow or block the process fluid flow through the valve cavity bore, first and second annular seat recesses separately receiving fixed and spring-driven seats having spherical surfaces engaging respective spherical surfaces on opposite sides of the flow control element, an end closure-connect comprising an attachment flange and an annular axial extension from the attachment flange received in the valve cavity bore opposite the Y-block, wherein the first annular seat recess is formed in an inner end of the annular axial extension. First and second sets of cooperating valve holes and studs removably secure the Y-end flanges and the attachment flange to the valve body, respectively. The second annular seat recess is formed in a coaxial annular shoulder formed around the valve cavity bore in the valve body between the flow control element and the Y-end flange, wherein the second annular seat recess is spaced from and independent of the Y-end flange. The Y-end flange has an outer diameter smaller than a diameter of the valve body, wherein the cooperating holes and studs of the first set comprise Y-end holes spaced radially between the outer diameter of the Y-end flange and a projection of a diameter of the valve cavity bore.
Embodiment 3: The Y-pattern valve assembly of Embodiment 2 or Embodiment 2A, wherein the main leg and Y legs are integrally formed with the main body of the Y-block, preferably wherein the Y-block is monolithic. Each Y leg is coaxial with the valve cavity bore and the central portion defines an annular space around the central portion between the Y-end flange and the main body. The studs of the at least one or first set penetrate the valve body in threaded engagement therewith and are axially retractable into the annular space. A depth of the penetration into the valve body is less than an axial distance through the annular space from ends of the studs to the main body such that the studs can be completely retracted into the annular space to disengage the Y-end flange from the valve body and move the valve body laterally with respect to the Y-end flange. Preferably, a total length of the studs exceeds a total axial distance between the Y-end flange and the main body.
Embodiment 4: The Y-pattern valve assembly of Embodiment 2 or Embodiment 3, wherein a first gasket is disposed between the valve body and the Y-end flange to form a first seal; and a second gasket is disposed between the valve body and the first end closure-connect to form a second seal.
Embodiment 5: The Y-pattern valve assembly of Embodiment 4, wherein the first gasket is a delta gasket disposed in opposing, adjoining circumferential sealing grooves formed at a periphery of the process fluid flow passage; and the second gasket is a delta gasket disposed in opposing, adjoining circumferential sealing grooves formed in the valve body and the Y-end flange adjacent an outside diameter of the first annular axial extension.
Embodiment 6: The Y-pattern valve assembly of any one of Embodiments 2 to 5, wherein the first end closure-connect comprises a first end connect comprising a first clamping hub and the main leg comprises a second end connect comprising a second clamping hub.
Embodiment 7: The Y-pattern valve assembly of any one of Embodiments 2 to 6, wherein the fixed seat is disposed in the first annular seat recess and the spring-driven seat is disposed in the second annular seat recess.
Embodiment 8: The Y-pattern valve assembly of Embodiment 1, wherein in one or both ball valves, the first attachment flange also serves as the Y-end flange and wherein the at least one set of cooperating holes and studs removably secures the first attachment flange to the valve body.
Embodiment 8A: A Y-pattern valve assembly that includes: a Y-block comprising a relatively enlarged main body, a main leg and two Y legs connected to the main body, wherein the Y legs have respective Y-end flanges removably mated directly with valve bodies of respective ball valves, wherein the Y legs comprise central portions between the Y-end flanges and the main body having a smaller outside diameter relative to lateral dimension of the main body. There are process fluid flow passages through the main leg, Y legs, and ball valves. One or both ball valves include: a flow control element received in a valve cavity bore formed in the valve body to selectively allow or block the process fluid flow through the valve cavity bore. First and second annular seat recesses separately receive fixed and spring-driven seats having spherical surfaces engaging respective spherical surfaces on opposite sides of the flow control element. The Y-end flange is a first end closure-connect that includes a first attachment flange and a first annular axial extension from the first attachment flange received in the valve cavity bore. The first annular seat recess is formed in an inner end of the first annular axial extension. A set of cooperating valve holes and studs removably secures the first attachment flange to the valve body. The second annular seat recess is formed opposite the Y-block in a coaxial annular shoulder formed around the valve cavity bore in the valve body or in an inner end of a second annular axial extension from a second attachment flange of a second end closure-connect.
Embodiment 9: The Y-pattern valve assembly of Embodiment 8 or Embodiment 8A, wherein one or both ball valves comprise a transverse purge bore through the first attachment flange to the process fluid flow passage in the respective Y leg.
Embodiment 10: The Y-pattern valve assembly of any one of Embodiments 8, 8A, and 9, wherein the fixed seat is disposed in the first annular seat recess and the spring-driven seat is disposed in the second annular seat recess.
Embodiment 11: The Y-pattern valve assembly of any one of Embodiments 8 to 10, wherein the spring-driven seat is disposed in the first annular seat recess and the fixed seat is disposed in the second annular seat recess.
Embodiment 12: The Y-pattern valve assembly of any one of Embodiments 8 to 11, wherein the second annular seat recess is formed in the valve body in an annular shoulder formed around the process fluid flow passage at one end of the valve cavity bore away from the Y-block (preferably wherein the fixed seat is received in the first annular seat recess and the spring-driven seat is disposed in the second annular seat recess).
Embodiment 12A: A Y-pattern valve assembly that includes: a Y-block comprising a relatively enlarged main body, a main leg and two Y legs connected to the main body, wherein the Y legs have respective Y-end flanges removably mated directly with valve bodies of respective ball valves, wherein the Y legs comprise central portions between the Y-end flanges and the main body having a smaller outside diameter relative to lateral dimension of the main body. There are process fluid flow passages through the main leg, Y legs, and ball valves. One or both ball valves include a flow control element received in a valve cavity bore formed in the valve body to selectively allow or block the process fluid flow through the valve cavity bore. First and second annular seat recesses separately receive fixed and spring-driven seats having spherical surfaces engaging respective spherical surfaces on opposite sides of the flow control element. An end closure-connect includes the Y-end flange as an attachment flange and an annular axial extension from the attachment flange is received in the valve cavity bore. The first annular seat recess is formed in an inner end of the annular axial extension. A set of cooperating valve holes and studs removably secures the attachment flange to the valve body. The second annular seat recess is formed opposite the Y-block in a coaxial annular shoulder formed around the valve cavity bore in the valve body at one end of the valve cavity bore away from the Y-block (preferably wherein the fixed seat is received in the first annular seat recess and the spring-driven seat is disposed in the second annular seat recess).
Embodiment 13: The Y-pattern valve assembly of Embodiment 12 or Embodiment 12A wherein one or both ball valve bodies comprise a valve end connect integral with the valve body opposite the Y-block.
Embodiment 14: The Y-pattern valve assembly of any one of Embodiments 12 to 13, consisting of the Y-block with the integral end closure-connects and the two valve bodies bolted to the end closure-connects as the three main components, wherein the Y-pattern valve assembly comprises no more than two bolted joints.
Embodiment 15: The Y-pattern valve assembly of any one of Embodiments 8 to 11, wherein the second end closure-connect includes a second attachment flange and a second set of cooperating valve holes and studs (preferably in addition to the studs/holes from the first set) sealingly secures the second attachment flange to the valve body, wherein the valve cavity bore receives the second annular axial extension.
Embodiment 15A: A Y-pattern valve assembly that includes: a Y-block comprising a relatively enlarged main body, a main leg and two Y legs connected to the main body, wherein the Y legs have respective Y-end flanges removably mated directly with valve bodies of respective ball valves, wherein the Y legs comprise central portions between the Y-end flanges and the main body having a smaller outside diameter relative to lateral dimension of the main body. There are process fluid flow passages through the main leg, Y legs, and ball valves. One or both ball valves include: a flow control element received in a valve cavity bore formed in the valve body to selectively allow or block the process fluid flow through the valve cavity bore. First and second annular seat recesses separately receive fixed and spring-driven seats having spherical surfaces engaging respective spherical surfaces on opposite sides of the flow control element. The Y-end flange is a first attachment flange of a first end closure-connect that includes a first annular axial extension from the first attachment flange received in the valve cavity bore. The first annular seat recess is formed in an inner end of the first annular axial extension. A set of cooperating valve holes and studs removably secures the first attachment flange to the valve body. The second annular seat recess is formed opposite the Y-block in an inner end of a second annular axial extension from a second attachment flange of a second end closure-connect received in the valve cavity bore, wherein the second end closure-connect includes a second attachment flange and a second set of cooperating valve holes and studs (preferably in addition to the studs/holes from the first set) sealingly secures the second attachment flange to the valve body.
Embodiment 16: The Y-pattern valve assembly of Embodiment 15 or Embodiment 15A, wherein the second end closure-connect includes an end connect comprising a clamping hub opposite the Y-block.
Embodiment 17: The Y-pattern valve assembly of any one of Embodiments 1 to 16, wherein: the Y-block is monolithic and/or the Y-block main leg comprises an end connect comprising a clamping hub.
Embodiment 18: The Y-pattern valve assembly of any one of any one of Embodiments 1 to 17, wherein gaskets, preferably delta gaskets, are disposed in opposing sealing grooves formed in the valve bodies, Y-end flanges, first end closure-connect flanges, and/or second end closure-connect flanges.
Embodiment 19: The Y-pattern valve assembly of any one of any one of Embodiments 1 to 18, wherein: the Y-block is monolithic; the Y-block main leg comprises an end connect comprising a clamping hub; and wherein gaskets, preferably delta gaskets, are disposed in opposing sealing grooves formed in the valve bodies, Y-end flanges, first end closure-connect flanges, and/or second end closure-connect flanges.
Embodiment 20: The Y-pattern valve assembly of any one of Embodiments 1 to 19, wherein both ball valves have the same configurations of: the flow control element received in the valve cavity bore formed in the valve body to selectively allow or block flow through the valve cavity bore; the first and second annular seat recesses separately receiving the fixed and spring-driven seats having spherical surfaces engaging respective spherical surfaces on opposite sides of the flow control element; the first end closure-connect comprising the first attachment flange and the first annular axial extension from the first attachment flange; and the at least one set of cooperating valve holes and studs sealingly securing the first attachment flange to the valve body; and the second annular seat formation in the valve body or the second end-closure connect.
Embodiment 21: A method of operating the Y-pattern valve assembly of any one of Embodiments 1 to 20, including selectively operating the flow control elements in the ball valves between opened and closed positions for process fluid flow through one or both ball valves and blocking the process fluid flow through one or both ball valves.
Embodiment 22: A method of operating the Y-pattern valve assembly of any one of Embodiments 9 and Embodiments 10 to 20 when dependent on Embodiment 9, including selectively operating the flow control element in the ball valves between opened and closed positions for process fluid flow through one or both ball valves and blocking the process flow through one or both ball valves, and supplying purge fluid through the purge bores to purge the process fluid flow passages in the respective Y legs.
Embodiment 23: The method of Embodiment 22, including independently rotating the flow control element of the ball valves from an open position to a closed position, and supplying the purge fluid through the purge bores of the ball valves to purge the process fluid flow passage during and/or after the rotation of the respective flow control element to the closed position.
Embodiment 24: A method of operating the Y-pattern valve assemblies of any one of Embodiments 1 to 20, including positioning a first one of the Y-pattern valve assemblies in first location in a process (preferably an inlet side of a redundant pathway process); positioning a second one of the Y-pattern valve assemblies in a second location of the process (preferably an outlet side of the redundant pathway process), wherein the first location (inlet side) is normally at a higher pressure than the second location (outlet side); serviceably positioning the fixed seats in the ball valves of the first and second Y-pattern valve assemblies on normally low pressure sides with respect to the flow control elements (preferably opposite the Y ends in the first Y-pattern valve assembly and adjacent the Y ends in the second Y-pattern valve assembly); selectively operating the flow control elements in the ball valves in the first and second Y-pattern valve assemblies between opened and closed positions for process fluid flow through one or both ball valves and blocking the process fluid flow through one or both ball valves.
Embodiment 25: The method of operating the Y-pattern valve assemblies according to Embodiment 24, wherein the first Y-pattern valve assembly comprises the Y-pattern valve assembly according to any one of Embodiments 8, 15, 15A, and 16 wherein the fixed seat is opposite the Y-block, and wherein the second Y-pattern valve assembly comprises the Y-pattern valve assembly according to any one of Embodiments 12, 12A, 13, 14, 15, 15A, and 16 wherein the fixed seat is adjacent the Y-block; preferably wherein the first Y-pattern valve assembly comprises the Y-pattern valve assembly according to Embodiment 8 wherein the fixed seat is opposite the Y-block, and wherein the second Y-pattern valve assembly comprises the Y-pattern valve assembly according to any one of Embodiments 12, 12A, 13, and 14, wherein the fixed seat is adjacent the Y-block; more preferably, wherein the first Y-pattern valve assembly comprises the Y-pattern valve assembly according to any one of Embodiments 15, 15A, and 16 wherein the fixed seat is opposite the Y-block, and wherein the second Y-pattern valve assembly comprises the Y-pattern valve assembly according to any one of Embodiments 15, 15A, and 16 wherein the fixed seat is adjacent the Y-block.

The foregoing disclosure illustrates embodiments where both ball valves of the Y-pattern valve assembly are preferably identical or similar; however, it is also contemplated that the ball valves disclosed herein can be mixed, e.g., one of the ball valve/Y-end flange arrangements of FIGS. 1-7, FIGS. 8-10, or of FIGS. 11-13 could be used in one of the Y ends with another one of the ball valve/Y-end flange arrangements illustrated.

The invention is described above in reference to specific examples and embodiments. The metes and bounds of the invention are not to be limited by the foregoing disclosure, which is illustrative only, but should be determined in accordance with the full scope and spirit of the appended claims. Various modifications will be apparent to those skilled in the art in view of the description and examples. It is intended that all such variations within the scope and spirit of the appended claims be embraced thereby. It is the express intention of the applicant not to invoke 35 U.S.C. § 112(f) in the US for any limitations of any of the claims herein, except for those in which the claim expressly uses the words ‘means for’ together with an associated function and without any recitation of structure. The priority document is incorporated herein by reference.

1. A Y-pattern valve assembly, comprising:
a Y-block comprising a relatively enlarged main body, a main leg and two Y legs connected to the main body, wherein the Y legs have respective Y-end flanges removably mated directly with valve bodies of respective ball valves, wherein the Y legs comprise central portions between the Y-end flanges and the main body having a smaller outside diameter relative to lateral dimension of the main body;
process fluid flow passages through the main leg, Y legs, and ball valves;
wherein one or both ball valves comprise:
a flow control element received in a valve cavity bore formed in the valve body to selectively allow or block the process fluid flow through the valve cavity bore;
first and second annular seat recesses separately receiving fixed and spring-driven seats having spherical surfaces engaging respective spherical surfaces on opposite sides of the flow control element;
a first end closure-connect comprising a first attachment flange and a first annular axial extension from the first attachment flange received in the valve cavity bore, wherein the first annular seat recess is formed in an inner end of the first annular axial extension;
at least one set of cooperating valve holes and studs removably securing the Y-end flanges and/or the first attachment flange to the valve body; and
wherein the second annular seat recess is formed in a coaxial annular shoulder formed around the valve cavity bore in the valve body or in an inner end of a second annular axial extension from a second attachment flange of a second end closure-connect.

2. The Y-pattern valve assembly of claim 1, wherein:
the first end closure-connect is disposed opposite the Y-block;
the annular shoulder is disposed between the flow control element and the Y-end flange;
the second annular seat recess is spaced from and independent of the Y-end flange;
the Y-end flange has an outer diameter smaller than a diameter of the valve body, wherein the cooperating holes and studs of the at least one set comprise Y-end holes spaced radially between the outer diameter of the Y-end flange and a projection of a diameter of the valve cavity bore to secure the Y-end flanges to the valve bodies; and
second sets of cooperating valve holes and studs removably secure the attachment flanges of the first end closure-connects to the valve bodies.

3. The Y-pattern valve assembly of claim 2, wherein:
the main leg and Y legs are integrally formed with the main body of the Y-block, wherein the Y-block is monolithic;
each Y leg is coaxial with the valve cavity bore and the central portion defines an annular space around the central portion between the Y-end flange and the main body;
the studs of the at least one set penetrate the valve body in threaded engagement therewith and are axially retractable into the annular space; and
a depth of the penetration into the valve body is less than an axial distance through the annular space from ends of the studs to the main body such that the studs can be completely retracted into the annular space to disengage the Y-end flange from the valve body and move the valve body laterally with respect to the Y-end flange, wherein a total length of the studs exceeds a total axial distance between the Y-end flange and the main body.

4. The Y-pattern valve assembly of claim 2, wherein:
a first gasket is disposed between the valve body and the Y-end flange to form a first seal; and
a second gasket is disposed between the valve body and the first end closure-connect to form a second seal.

5. The Y-pattern valve assembly of claim 4, wherein:
the first gasket is a delta gasket disposed in opposing, adjoining circumferential sealing grooves formed at a periphery of the process fluid flow passage; and
the second gasket is a delta gasket disposed in opposing, adjoining circumferential sealing grooves formed in the valve body and the Y-end flange adjacent an outside diameter of the first annular axial extension.

6. The Y-pattern valve assembly of claim 2, wherein:
the first end closure-connect comprises a first end connect comprising a first clamping hub; and
the main leg comprises a second end connect comprising a second clamping hub.

7. The Y-pattern valve assembly of claim 2, wherein the fixed seat is disposed in the first annular seat recess and the spring-driven seat is disposed in the second annular seat recess.

8. The Y-pattern valve assembly of claim 1, wherein in one or both ball valves, the first attachment flange also serves as the Y-end flange and wherein the at least one set of cooperating holes and studs removably secures the first attachment flange to the valve body.

9. The Y-pattern valve assembly of claim 8, wherein one or both ball valves comprise a transverse purge bore through the first attachment flange to the process fluid flow passage in the respective Y leg.

10. The Y-pattern valve assembly of claim 8, wherein the fixed seat is disposed in the first annular seat recess and the spring-driven seat is disposed in the second annular seat recess.

11. The Y-pattern valve assembly of claim 8, wherein the spring-driven seat is disposed in the first annular seat recess and the fixed seat is disposed in the second annular seat recess.

12. The Y-pattern valve assembly of claim 8, wherein the second annular seat recess is formed in the valve body in an annular shoulder formed around the process fluid flow passage at one end of the valve cavity bore away from the Y-block.

13. The Y-pattern valve assembly of claim 12, wherein one or both ball valve bodies comprise a valve end connect integral with the valve body opposite the Y-block.

14. The Y-pattern valve assembly of claim 13, consisting of the Y-block with the integral end closure-connects and the two valve bodies bolted to the end closure-connects as the three main components.

15. The Y-pattern valve assembly of claim 8, wherein:
the second end closure-connect comprises a second attachment flange; and
a second set of cooperating valve holes and studs sealingly secures the second attachment flange to the valve body, wherein the valve cavity bore receives the second annular axial extension.

16. The Y-pattern valve assembly of claim 15, wherein the second end closure-connect comprises an end connect comprising a clamping hub opposite the Y-block.

17. The Y-pattern valve assembly of claim 1, wherein:
the Y-block is monolithic;
the main leg comprises an end connect comprising a clamping hub;
delta gaskets are disposed in opposing sealing grooves formed in the valve bodies, Y-end flanges, first end closure-connect flanges, and/or second end closure-connect flanges;
the spring-driven seat of the one or both ball valves is biased by an inner spring in an inner spring pocket formed about the process fluid flow passage adjacent an inside diameter of the spring-driven seat and biasing an end surface of the spring-driven seat, and an outer spring in an outer spring pocket formed adjacent an outside diameter of the spring-driven seat and biasing an outwardly-extending flange on the spring-driven seat; and/or
the fixed seat of the one or both ball valves is sealingly engaged between the flow control element and an annular raised face formed in one of the first and second annular seat recesses, wherein the fixed seat is biased against the raised face by a seat locking ring engaging an outer radial edge of the fixed seat and secured by a plurality of radially spaced threaded members.

18. A method of operating the Y-pattern valve assembly of claim 1, comprising selectively operating the flow control elements in the ball valves between opened and closed positions for process fluid flow through one or both ball valves and blocking the process fluid flow through one or both ball valves.

19. A method of operating the Y-pattern valve assembly of claim 9, comprising:
selectively operating the flow control elements in the ball valves between opened and closed positions for process fluid flow through one or both ball valves and blocking the process flow through one or both ball valves;
supplying purge fluid through the purge bores to purge the process fluid flow passages in the respective Y legs; and
independently rotating the flow control element of the ball valves from an open position to a closed position and supplying the purge fluid through the purge bores of the ball valves to purge the process fluid flow passages during, after, or both during and after the rotation of the respective flow control element to the closed position.

20. The method of claim 18, wherein a first one of the flow control elements in the ball valves is open for process fluid flow therethrough and a second one of the flow control elements in the ball valves is closed to block the process fluid flow therethrough, further comprising:
opening the second flow control element while keeping the first flow control element open for simultaneous process fluid flow through both the first and the second flow control elements;
then closing the first flow control element to block process fluid flow therethrough while keeping the second flow control element open to maintain process fluid flow therethrough; and
purging process fluid flow passages during, after, or both during and after closing the first flow control element.
